(19) United States
(12) Patent Application Publication
(10) Pub. No.: US 2026/0129606 A1
(43) Pub. Date: May 7, 2026

(54) ELECTRONIC DEVICE FOR DETERMINING POSITION OF USER TERMINAL AND METHOD OF OPERATING THE SAME

(71) Applicant: Electronics and Telecommunications Research Institute, Daejeon (KR)

(72) Inventors: Jin Ah Kang, Daejeon (KR); Youngsu Cho, Seoul (KR)

(21) Appl. No.: 19/284,545

(22) Filed: Jul. 29, 2025

(30) Foreign Application Priority Data
Apr. 3, 2025 (KR) 10-2025-0043575
Nov. 5, 2024 (KR) 10-2024-0155149

(51) Int. Cl. H04W 64/00

(52) U.S. Cl. CPC H04W 64/00

(57) ABSTRACT

An electronic device for determining a position of a user terminal and a method of operating the electronic device are provided. The method of operating the electronic device include receiving a request for measuring a position of a user terminal and a piece of reference cell information of a base station connected with the user terminal, in response to the request for measuring the position of the user terminal, based on the piece of reference cell information, generating one or more pieces of neighboring cell information corresponding to the base station, and based on the piece of reference cell information and the one or more pieces of neighboring cell information, determining the position of the user terminal.

### CROSS-REFERENCE TO RELATED APPLICATION

This application claims the benefit of Korean Patent Application No. 10-2024-0155149, filed on November 5, 2024 and Korean Patent Application No. 10-2025-0043575, filed on April 3, 2025, in the Korean Intellectual Property Office, the entire disclosures of which are incorporated herein by reference for all purposes.

### BACKGROUND

### 1. Field of the Invention

One or more embodiments relate to an electronic device for determining a position of a user terminal and a method of operating the same.

### 2. Description of the Related Art

As the use and number of user terminals increase and services provided based on position become more diverse, technology for measuring the positions of user terminals are being researched. The position of a user terminal may be measured using cell information of a base station providing services to the user terminal. For example, to measure the position of a user terminal, the position of the region covered by the cell to which the user terminal is connected, the round-trip time (RTT) of a signal between the base station and the user terminal, the angle of arrival (AOA) of the signal, or the time difference of arrival (TDOA) of the signal may be utilized.

The above description is information the inventor(s) acquired during the course of conceiving the present disclosure, or already possessed at the time, and is not necessarily art publicly known before the present application was filed.

### SUMMARY

Various embodiments may determine a position of a user terminal by generating pieces of neighboring cell information based on a piece of reference cell information of a base station to which the user terminal is connected.

Various embodiments may determine the position of the user terminal by identifying a relationship between a piece of cell information and a position through artificial intelligence (AI)-based natural language processing.

Various embodiments may train a first model for generating pieces of neighboring cell information based on a piece of cell information and a second model for determining a position of a user terminal based on pieces of cell information.

Other objects and advantages of the present disclosure can be understood by the following description and will become more apparent by the embodiments of the present disclosure. In addition, it will be apparent that the objects and advantages of the present disclosure can be readily realized by the means and combinations thereof recited in the claims.

According to an aspect, there is provided a method of operating an electronic device including receiving a request for measuring a position of a user terminal and a piece of reference cell information of a base station connected with the user terminal, in response to the request for measuring the position of the user terminal, based on the piece of reference cell information, generating one or more pieces of neighboring cell information corresponding to the base station, and based on the piece of reference cell information and the one or more pieces of neighboring cell information, determining the position of the user terminal.

The generating of the one or more pieces of neighboring cell information may include, using a first model that is pretrained with a sequence of the piece of reference cell information and the one or more pieces of neighboring cell information corresponding to the piece of reference cell information, generating the one or more pieces of neighboring cell information.

The receiving of the piece of reference cell information may further include receiving pieces of reference neighboring cell information of base stations of a telecommunication company that is same as a telecommunication company of the base station, and the generating of the one or more pieces of neighboring cell information may include, based on the piece of reference cell information and the pieces of reference neighboring cell information, generating the one or more pieces of neighboring cell information.

The first model may include a long short-term memory (LSTM) layer configured to generate a context vector based on the piece of reference cell information and the pieces of reference neighboring cell information.

The determining of the position of the user terminal may include, using a second model that is pretrained with a piece of multi-cell information comprising the piece of reference cell information and the one or more pieces of neighboring cell information and a position, determining the position of the user terminal.

The second model may include an LSTM layer for determining a position corresponding to the piece of multi-cell information.

The one or more pieces of neighboring cell information may include pieces of cell information of a base station of a telecommunication company that is different from a telecommunication company of the base station.

The determining of the position of the user terminal may include determining probabilities that the user terminal is positioned in each of predetermined zones.

According to another aspect, there is provided a method of operating an electronic device including, according to a position of a user terminal, obtaining one or more pieces of cell information of base stations connectable to the user terminal and based on the one or more pieces of cell information, training a first model to generate one or more pieces of cell information corresponding to a piece of input cell information.

The training of the first model may include training the first model by grouping pieces of cell information of base stations of a same telecommunication company among the one or more pieces of cell information.

Each of the one or more pieces of cell information may include a cell identifier and a channel number of a corresponding cell, and the training of the first model may include training the first model by generating sequences based on the cell identifier and the channel number of each of the one or more pieces of cell information and matching the generated sequences to one another based on a telecommunication company.

The method may further include, based on a piece of multi-cell information comprising the one or more pieces of cell information, training a second model to determine the position of the user terminal corresponding to the piece of input cell information.

The training of the second model may include, based on a piece of mapping information between a zone corresponding to the position of the user terminal among predetermined zones and the piece of multi-cell information, training the second model.

According to another aspect, there is provided an electronic device including a processor and a memory storing instructions, wherein the instructions, when executed by the processor, may cause the electronic device to receive a request for a position of a user terminal and a piece of reference cell information of a base station connected with the user terminal, in response to the request for the position of the user terminal, based on the piece of reference cell information, generate one or more pieces of neighboring cell information corresponding to the base station, and based on the piece of reference cell information and the one or more pieces of neighboring cell information, determine the position of the user terminal.

The instructions, when executed by the processor, may cause the electronic device to, using a first model that is pretrained with a sequence of the piece of reference cell information and the one or more pieces of neighboring cell information corresponding to the piece of reference cell information, generate the one or more pieces of neighboring cell information.

The instructions, when executed by the processor, may cause the electronic device to further receive pieces of reference neighboring cell information of base stations of a telecommunication company that is same as a telecommunication company of the base station and based on the piece of reference cell information and the pieces of reference neighboring cell information, generate the one or more pieces of neighboring cell information.

The first model may include an LSTM layer configured to generate a context vector based on the piece of reference cell information and the pieces of reference neighboring cell information.

The instructions, when executed by the processor, may cause the electronic device to, using a second model that is pretrained with a piece of multi-cell information comprising the piece of reference cell information and the one or more pieces of neighboring cell information and a position, determine the position of the user terminal.

The second model may include an LSTM layer for determining a position corresponding to the multi-cell information.

The one or more pieces of neighboring cell information may include pieces of cell information of a base station of a telecommunication company that is different from a telecommunication company of the base station.

The instructions, when executed by the processor, may cause the electronic device to determine probabilities that the user terminal is positioned in each of predetermined zones.

Additional aspects of embodiments will be set forth in part in the description which follows and, in part, will be apparent from the description, or may be learned by practice of the disclosure.

Various embodiments may more accurately measure a position of a user terminal and reduce an error caused by a physical environment using a piece of cell information of a base station to which the user terminal is connected, rather than using values measured through a signal.

Various embodiments may reduce measurement costs compared to a position measurement method that utilizes various resources by measuring a position of a user terminal using a piece of cell information of a base station.

Various embodiments may reduce positioning delays during position measurement, simplify model structures, and increase inference speed, thereby being advantageous for real-time services, by using point information obtained at the current time point instead of past and present time-variant information based on wireless signal characteristics.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a positioning system and an electronic device according to an embodiment;

FIG. 2 is a diagram illustrating a process in which an electronic device determines a position of a user terminal, according to an embodiment;

FIG. 3 is a diagram illustrating an operation of generating one or more pieces of neighboring cell information using a first model, according to an embodiment;

FIG. 4 is a diagram illustrating a structure of a first model, according to an embodiment;

FIG. 5 is a diagram illustrating a training dataset of a first model, according to an embodiment;

FIG. 6 is a diagram illustrating an operation of determining a position of a user terminal using a second model, according to an embodiment;

FIG. 7 is a diagram illustrating a structure of a second model according to an embodiment;

FIG. 8 is a diagram illustrating a training dataset for a second model, according to an embodiment;

FIG. 9 is a flowchart illustrating a method of operating an electronic device during an inference process, according to an embodiment;

FIG. 10 is a flowchart illustrating a method of operating an electronic device in a training process, according to an embodiment; and

FIG. 11 is a block diagram illustrating an electronic device according to an embodiment.

### DETAILED DESCRIPTION

The following structural or functional descriptions of embodiments are provided as examples only, and various alterations and modifications may be made to the embodiments. Accordingly, the embodiments are not construed as limited to the disclosure and should be understood to include all changes, equivalents, and replacements within the idea and the technical scope of the disclosure.

As used herein, "A or B", "at least one of A and B", "at least one of A or B", "A, B or C", "at least one of A, B and C", "at least one of A, B, or C", and "one or a combination of at least two of A, B, and C," each of which may include any one of the items listed together in the corresponding one of the phrases, or all possible combinations thereof. Although terms, such as first, second, and the like, may be used herein to describe various components, these terms should be used only to distinguish one component from another component. For example, a first component may be referred to as a second component, and similarly the second component may also be referred to as the first component.

It should be noted that if one component is described as being "connected", "coupled", or "joined" to another component, a third component may be "connected", "coupled", and "joined" between the first and second components, although the first component may be directly connected, coupled, or joined to the second component.

The singular forms "a", "an", and "the" are intended to include the plural forms as well, unless the context clearly indicates otherwise. It will be further understood that the terms "comprises/comprising" and/or "includes/including" when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms used herein including technical or scientific terms have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments are described in detail with reference to the accompanying drawings. When describing the embodiments with reference to the accompanying drawings, like reference numerals refer to like elements and a repeated description related thereto will be omitted.

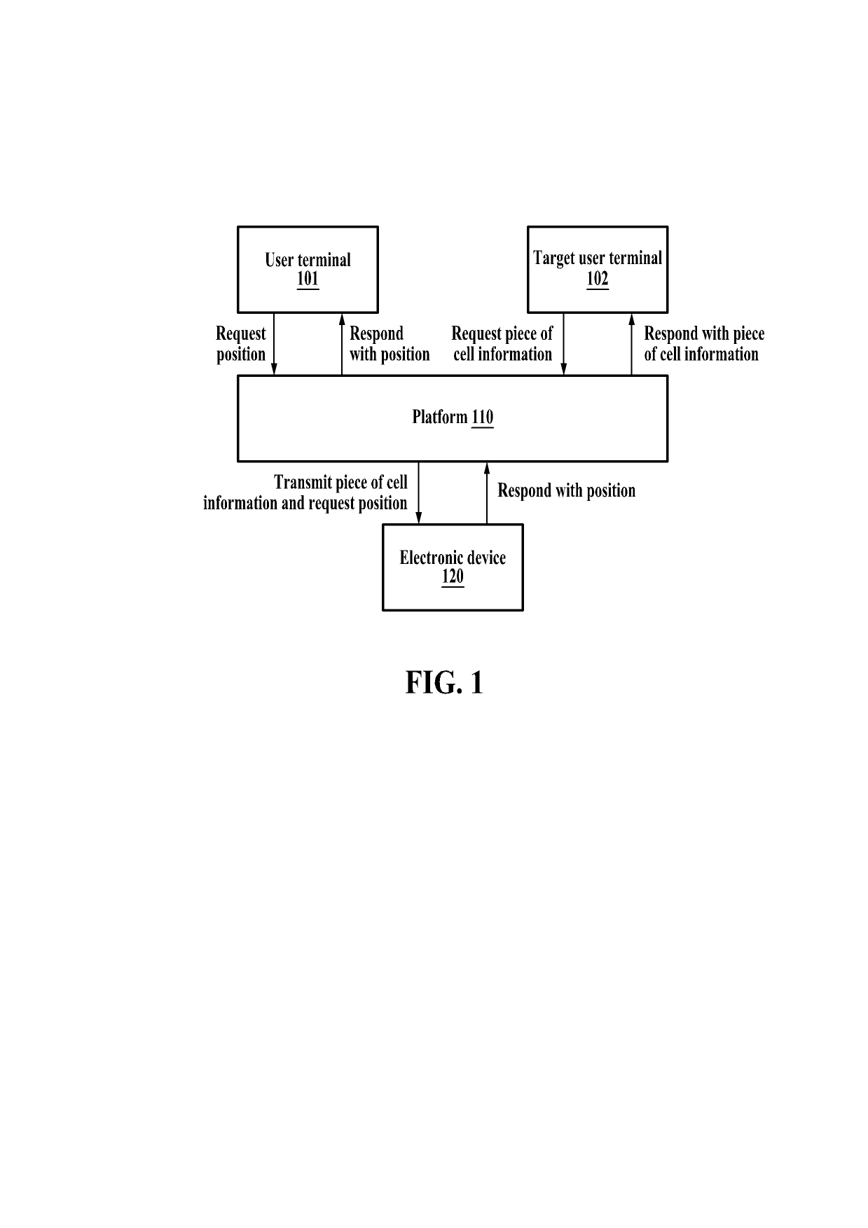

FIG. 1 is a diagram illustrating a positioning system and an electronic device according to an embodiment.

Referring to FIG. 1, a positioning system for measuring the position of a target user terminal 102 may include a platform 110 and an electronic device 120. Herein, positioning may refer to measuring a position.

The platform 110 may be a device, a server, or a program that transmits the position of a user terminal in response to a position measurement request. The platform 110 may receive a request for measuring the position of the target user terminal 102 from a user terminal 101 and transmit the position of the target user terminal 102 to the user terminal 101 in response to the request for measuring the position of the target user terminal 102. The platform 110 may communicate with the user terminal 101, the target user terminal 102, and an electronic device by wire or wirelessly to transmit and receive data to and from the user terminal 101, the target user terminal 102, and the electronic device. In FIG. 1, for ease of description, only the user terminal 101 and the target user terminal 102 connected to the platform 110 are illustrated, but the number of user terminals connected to the platform 110 may be plural. Additionally, in FIG. 1, the platform 110 is illustrated as a device separate from the electronic device 120. However, the embodiments are not limited thereto, and the platform 110 may be included in the electronic device 120 or implemented as software executed by the electronic device 120. For example, the platform 110 and the electronic device 120 may be implemented as a single device.

The electronic device 120 may be a server that determines the position of the target user terminal 102. Additionally, the electronic device 120 may include various computing devices such as a mobile phone, a smartphone, a tablet, an e-book device, a laptop computer, a personal computer (PC), a desktop computer, a workstation, or a server, various wearable devices such as a smartwatch, smart glasses, a head-mounted display (HMD), or smart clothing, various home appliances such as a smart speaker, a smart television (TV), or a smart refrigerator, a smart car, a smart kiosk, an Internet of Things (IoT) device, a walking assist device (WAD), a drone, or a robot. However, embodiments are not limited thereto. Herein, for ease of description, the electronic device 120 may also be referred to as a positioning server. In FIG. 1, the electronic device 120 is illustrated as a single device, but depending on the embodiment, the electronic device 120 may be implemented as a plurality of electronic devices. For example, the plurality of electronic devices may be disposed in each region, and each electronic device may communicate with one another by wire or wirelessly to transmit and receive data to and from one another.

The user terminal 101 may transmit a request for measuring the position of the target user terminal 102 to the platform 110. The target user terminal 102 may be one of a plurality of user terminals connected to the platform 110. In response to receiving the request for measuring the position of the target user terminal 102, the platform 110 may transmit, to the target user terminal 102, a request for a piece of reference cell information of a base station connected to the target user terminal 102. The target user terminal 102, in response to receiving the request for the piece of reference cell information, may transmit the piece of reference cell information to the platform 110. Additionally, the target user terminal 102 may further transmit, to the platform 110, pieces of information about a reference neighboring cell around a reference cell.

The reference cell may be a cell of a base station that provides a service to the target user terminal 102 at a current position. Herein, for ease of description, the reference cell may also be referred to as a serving cell. The piece of reference cell information may include an identifier (e.g., ID) of the reference cell and a channel number provided by the reference cell. The reference neighboring cell may be a cell within a range predetermined based on the reference cell or a cell within a range to provide a service to the target user terminal 102. A piece of reference neighboring cell information may include an identifier of the reference neighboring cell and a channel number provided by the reference neighboring cell.

The platform 110 may transmit the piece of reference cell information received from the target user terminal 102 to the electronic device 120 and request for measuring the position of the target user terminal 102. The electronic device 120, based on the piece of reference cell information, may determine the position of the target user terminal 102 and transmit the determined position to the platform 110. In an embodiment, the platform 110 may further transmit the pieces of reference neighboring cell information to the electronic device 120, and the electronic device 120 may determine the position of the target user terminal 102 based on the piece of reference cell information and the pieces of reference neighboring cell information. The platform 110 may transmit the position of the target user terminal 102 received from the electronic device 120 to the user terminal 101.

According to an embodiment, the electronic device 120 may generate one or more pieces of neighboring cell information based on the piece of reference cell information using a pretrained first model. The one or more pieces of neighboring cell information may be pieces of cell information from a base station of a telecommunication company that is different from the telecommunication company of the piece of reference cell information. For example, since the electronic device 120 may not obtain a piece of information about telecommunication companies the target user terminal 102 is not registered with, the electronic device 120 may generate pieces of information about the telecommunication companies the target user terminal 102 is not registered with. Additionally, the electronic device 120 may determine the position of the target user terminal 102 based on the one or more pieces of neighboring cell information using a pretrained second model. Through this, the electronic device 120 may measure the position of the target user terminal 102 more quickly and accurately from the piece of reference cell information of the base station to which the target user terminal 102 is connected.

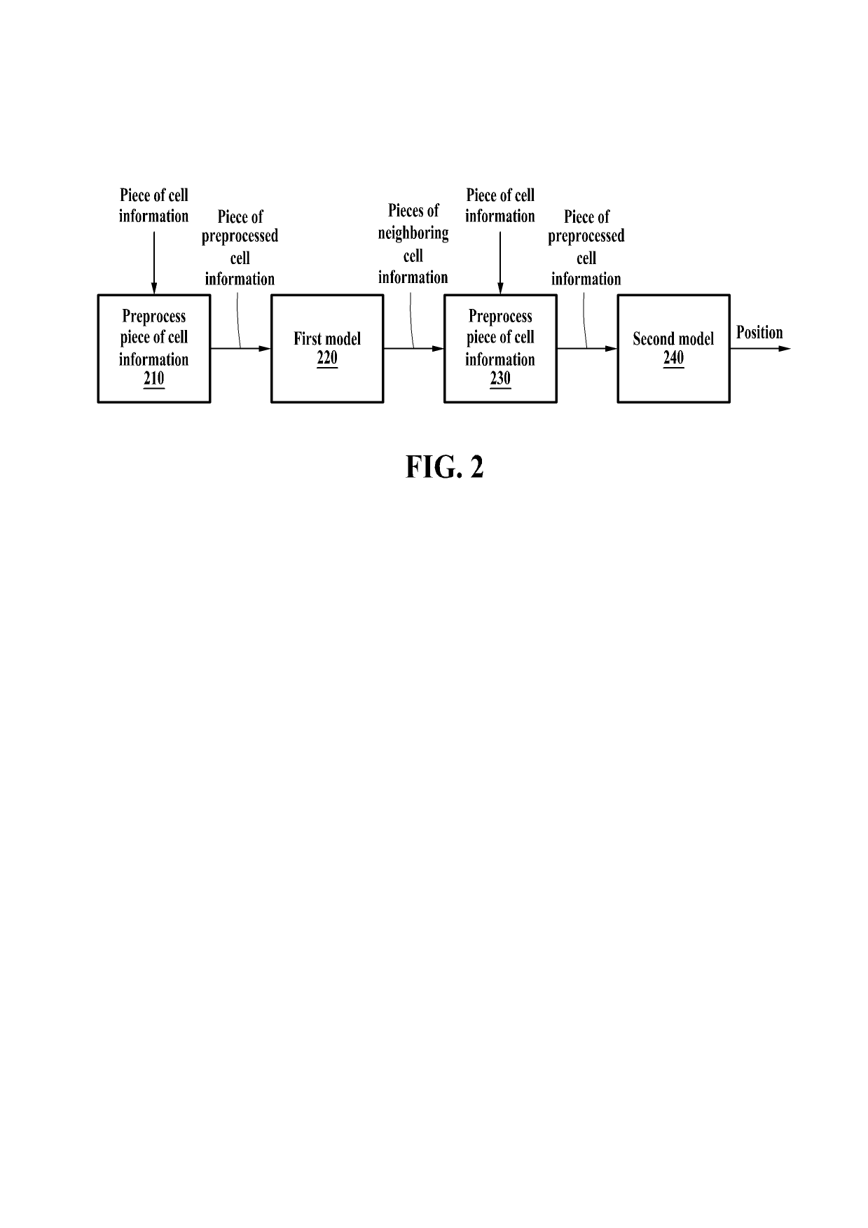

The operations in which the electronic device 120 determines the position of the user terminal are described in detail with reference to FIGS. 2 to 8.

FIG. 2 is a diagram illustrating a process in which an electronic device determines a position of a user terminal, according to an embodiment.

Referring to FIG. 2, the electronic device may determine the position of the user terminal through operations 210, 220, 230, and 240.

In operation 210, the electronic device may preprocess a piece of reference cell information received from the user terminal or a platform. When further receiving pieces of reference neighboring cell information, the electronic device may preprocess the pieces of reference neighboring cell information. For example, the electronic device may transform the piece of reference cell information and the pieces of reference neighboring cell information into a sequence to be input to a first model.

Each of the piece of reference cell information and the pieces of reference neighboring cell information may include a cell identifier and a channel number for a corresponding cell. For example, a cell identifier may include physical cell identification (ID) (PCI) or an eNodeB cell identifier (ECI) in a 4th generation (4G) network and gNodeB ID, new radio PCI (NR-PCI) or new radio cell global ID (NRCGI) in a 5G network. For example, a channel number may include evolved universal terrestrial radio access (E-UTRA) absolute radio frequency channel number (E-ARFCN) in the 4G network or NR-ARFCN in the 5G network. In an embodiment, the electronic device may combine cell identifiers and channel numbers included in the piece of reference cell information and the pieces of reference neighboring cell information with telecommunication company information (e.g., mobile network code (MNC)) to generate a sequence for each piece of cell information.

In operation 220, the electronic device may generate one or more pieces of neighboring cell information based on the preprocessed piece of reference cell information using a pretrained first model. The electronic device may augment the piece of reference cell information using the first model to generate the one or more pieces of neighboring cell information. For example, the electronic device may generate the one or more pieces of neighboring cell information using a cell identifier and a channel number included in the piece of reference cell information.

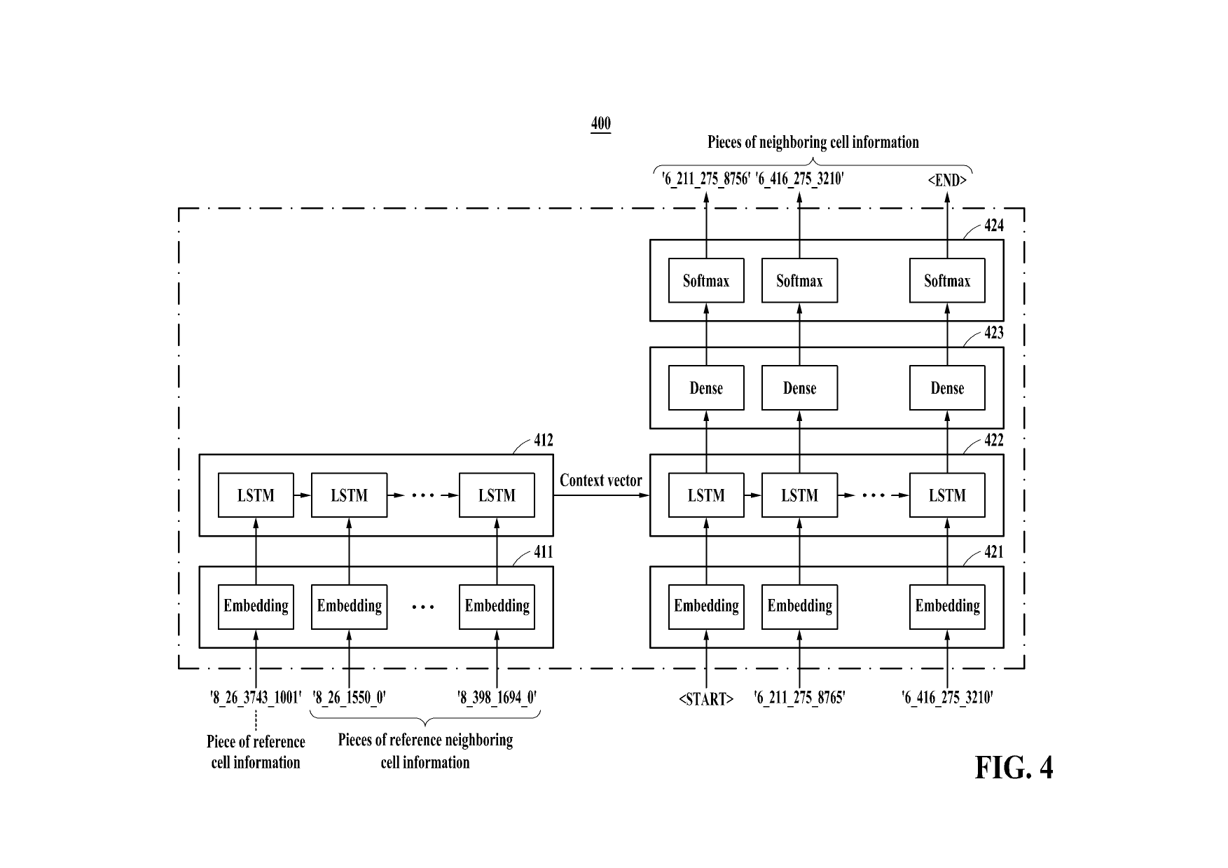

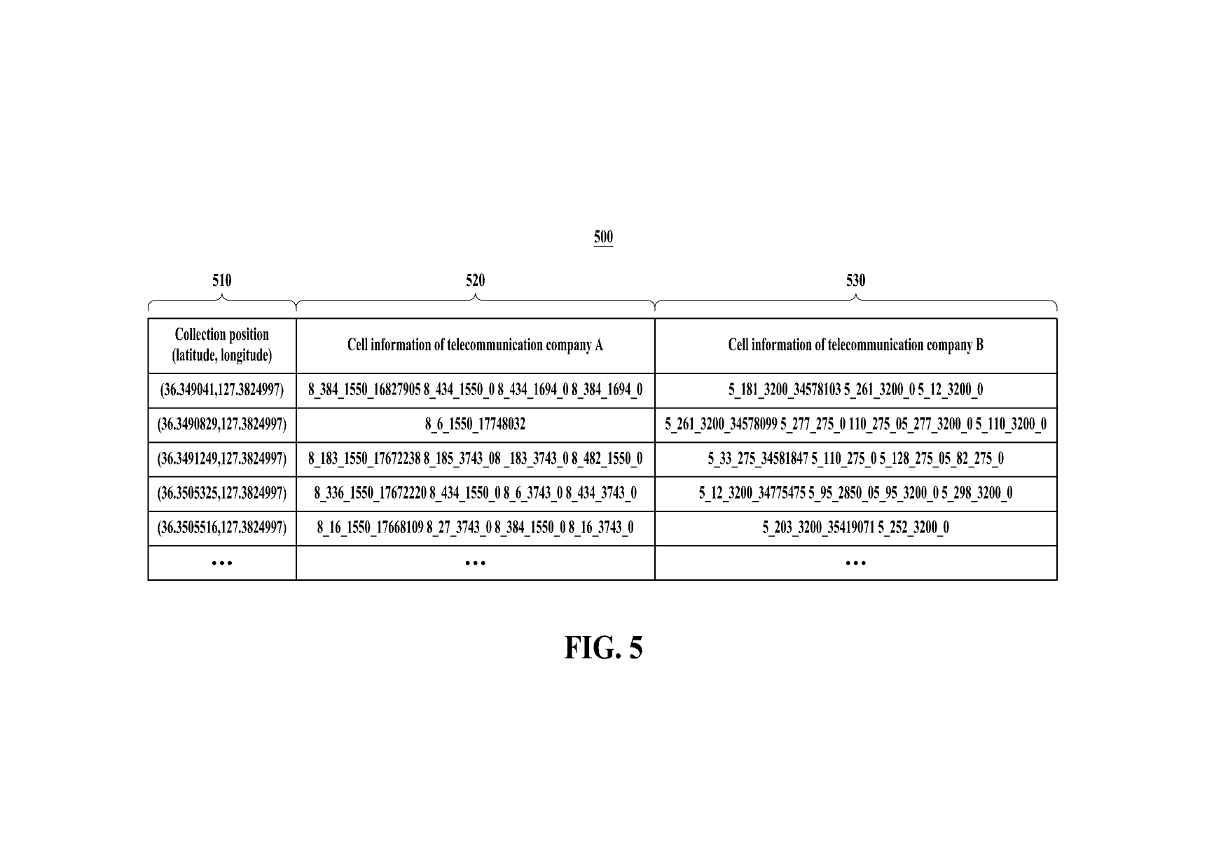

The first model may be pretrained based on artificial intelligence (AI). For example, the first model may be a deep learning model belonging to a recurrent neural network (RNN) family. For example, the first model may be a long short-term memory (LSTM) model, a gated recurrent unit (GRU) model, a sequence-to-sequence (Seq-to-Seq) model, or a transformer model. However, embodiments are not limited thereto. Herein, for ease of description, the first model may also be referred to as a neighboring cell information generation model. The training process and inference process of the first model are described in detail below with reference to FIGS. 4 and 5.

In operation 230, the electronic device may preprocess the piece of reference cell information and the generated one or more pieces of neighboring cell information. For example, the electronic device may generate a piece of multi-cell information including the piece of reference cell information and the generated one or more pieces of neighboring cell information. The electronic device may distinguish the piece of reference cell information and the generated one or more pieces of neighboring cell information based on a telecommunication company. Each piece of cell information included in the piece of multi-cell information may be determined as a combination of a piece of carrier information, a cell identifier, and a channel number.

In operation 240, the electronic device may determine the position of the user terminal based on the piece of preprocessed reference cell information and one or more pieces of neighboring cell information using a second model. The electronic device may determine the position of the user terminal based on the piece of multi-cell information including the piece of reference cell information and the one or more pieces of neighboring cell information.

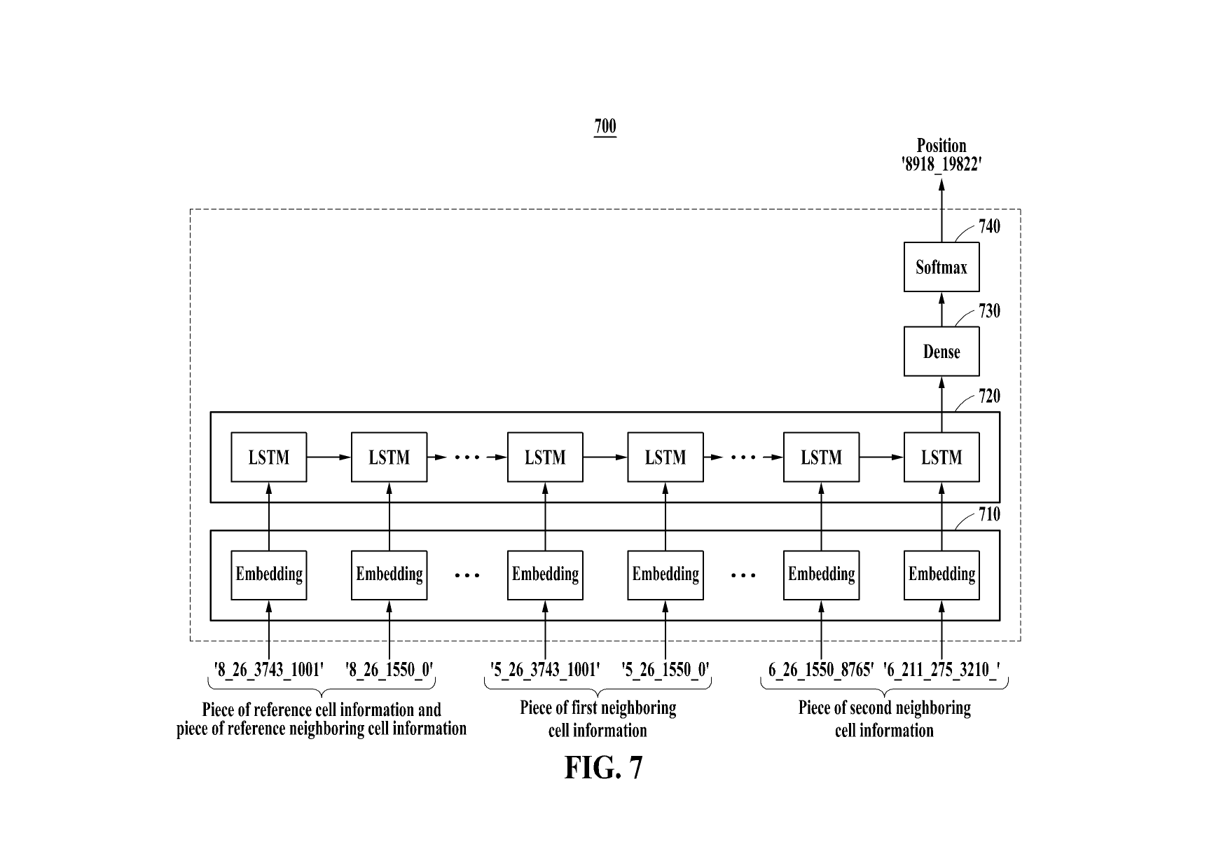

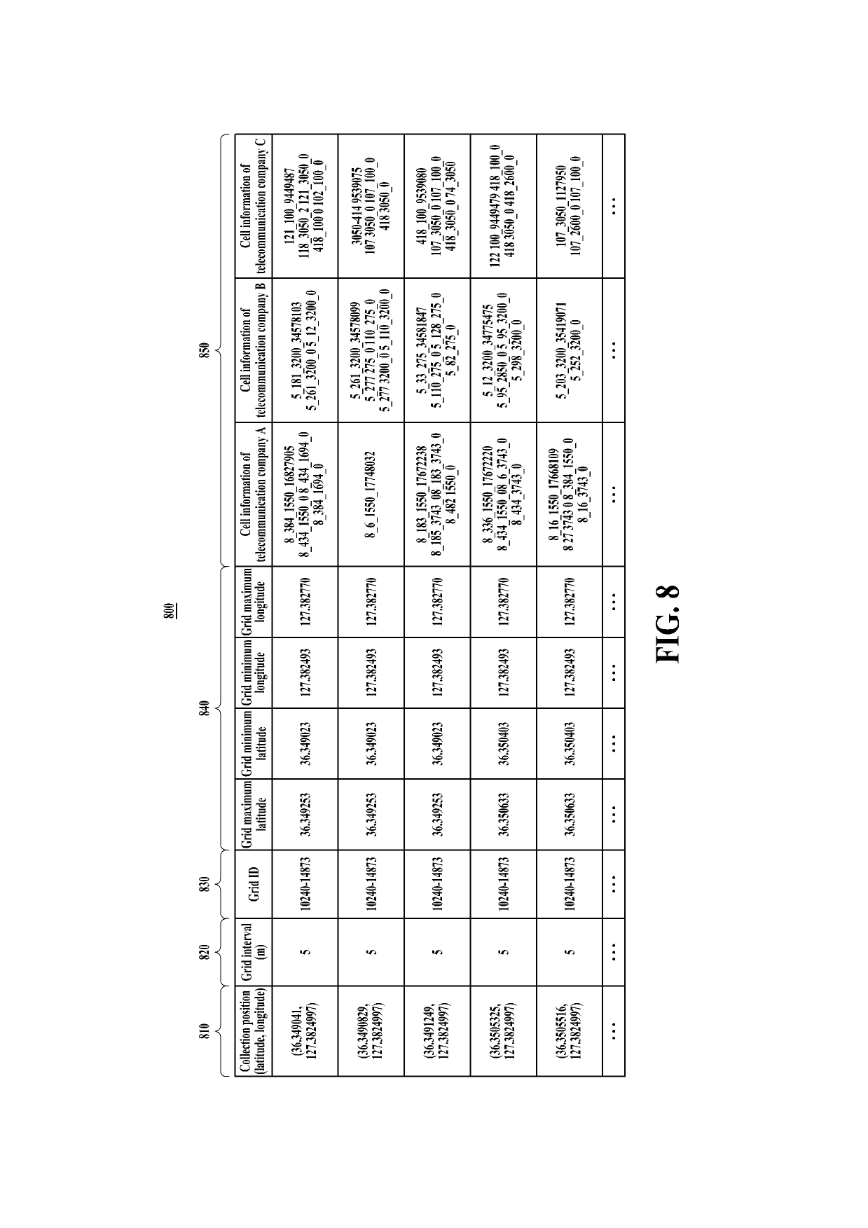

The second model may be pretrained based on AI. For example, the second model may be a deep learning model belonging to the RNN family. For example, the second model may be an LSTM model, a GRU model, a Seq-to-Seq model, or a transformer model. However, embodiments are not limited thereto. Herein, for ease of description, the second model may also be referred to as a position classification model. The training process and inference process of the second model are described in detail below with reference to FIGS. 7 and 8.

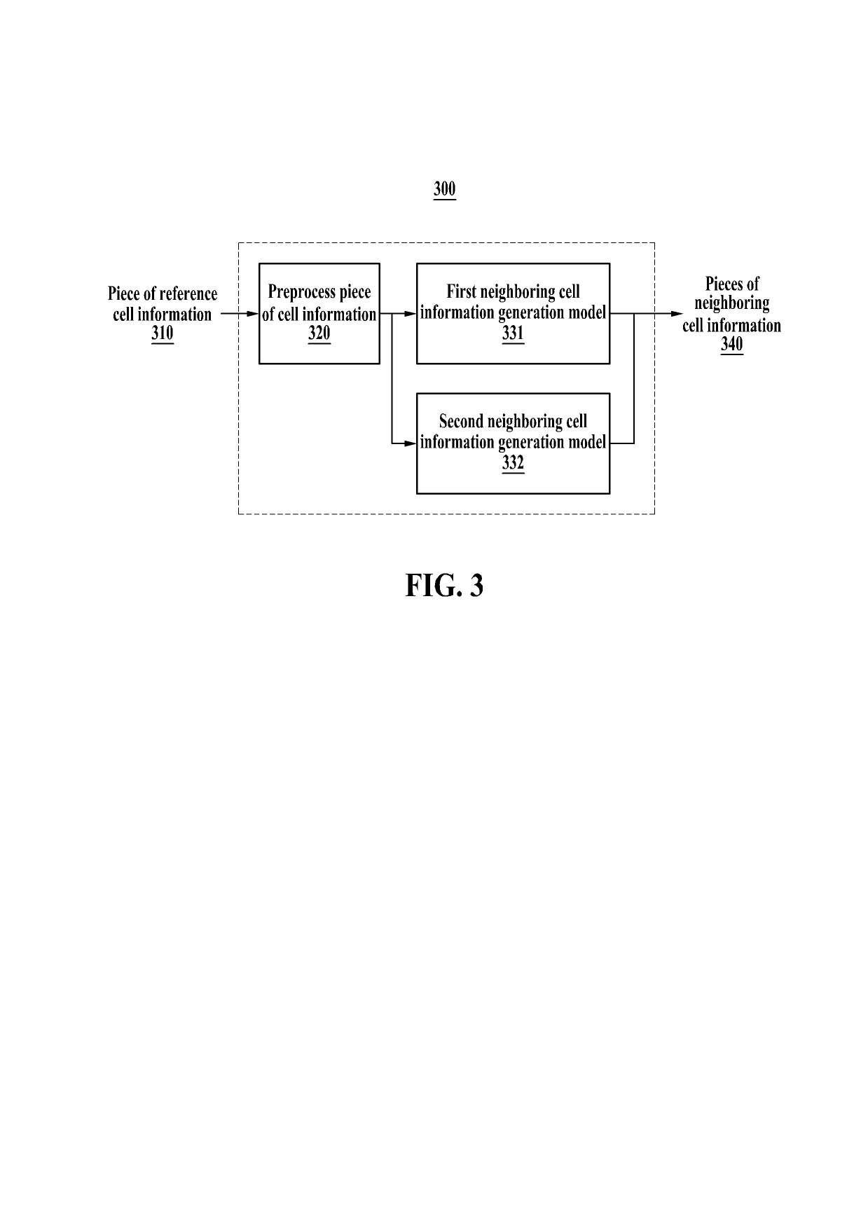

FIG. 3 is a diagram illustrating an operation of generating one or more pieces of neighboring cell information using a first model, according to an embodiment.

Referring to FIG. 3, an example of the functional structure of a first model 300 is illustrated. The first model 300 may include a plurality of neighboring cell information generation models (e.g., a first neighboring cell information generation model 331 and a second neighboring cell information generation model 332).

In operation 320, an electronic device may preprocess a piece of reference cell information 310. According to an embodiment, the first model 300 may preprocess the piece of reference cell information 310 and input the preprocessed piece of reference cell information 310 to the plurality of neighboring cell information generation models 331 and 332.

The plurality of neighboring cell information generation models 331 and 332 may generate one or more pieces of neighboring cell information 340 based on the piece of reference cell information 310. The generated one or more pieces of neighboring cell information 340 may be pieces of cell information for a telecommunication company that is different from the telecommunication company of the piece of reference cell information 310. Additionally, the first neighboring cell information generation model 331 and the second neighboring cell information generation model 332 may generate pieces of neighboring cell information of different telecommunication companies. For example, for a piece of reference cell information of telecommunication company A, the first neighboring cell information generation model 331 may generate one or more pieces of neighboring cell information of telecommunication company B, and the second neighboring cell information generation model 332 may generate one or more pieces of neighboring cell information of telecommunication company C. In FIG. 1, for explanatory purposes, only two neighboring cell information generation models 331 and 332 are illustrated. However, embodiments are not limited thereto, and the number of models may vary depending on the number of telecommunication companies.

In an embodiment, the plurality of neighboring cell information generation models 331 and 332 may generate the one or more pieces of neighboring cell information 340 based on the piece of reference cell information 310 and pieces of reference neighboring cell information.

Through this, the electronic device may determine the position of the user terminal by generating the one or more pieces of neighboring cell information 340 even for pieces of cell information that are not obtained.

The structures and operations of the plurality of neighboring cell information generation models 331 and 332 are described below in detail with reference to FIG. 4.

FIG. 4 is a diagram illustrating a structure of a first model, according to an embodiment.

Referring to FIG. 4, a first model 400 may include an embedding layer 411, an encoder 412, an embedding layer 421, a decoder 422, a dense layer 423, and a softmax layer 424. The first model 400 of FIG. 4 is implemented based on a Seq-to-Seq model. However, embodiments are not limited thereto, and the first model 400 may be implemented based on various AI models using different training and inference methods. Neural networks used in the encoder 412 and the decoder 422 are not limited to LSTM networks but may include various neural networks based on an RNN. For example, the encoder 412 may also use a neural network machine translation (NMT) model such as the RNN, a GRU, or a transformer.

The embedding layer 411 may receive a piece of reference cell information. Additionally, according to an embodiment, the embedding layer 411 may further receive pieces of reference neighboring cell information. The piece of reference cell information and the pieces of reference neighboring cell information may be sequentially input to the embedding layer 411.

The piece of reference cell information and the pieces of reference neighboring cell information input to the embedding layer 411 may be determined as a combination of telecommunication company information, cell identifiers, and channel numbers. For example, the piece of reference cell information and the pieces of reference neighboring cell information may be determined as a combination of MNC, PCI, E-ARFCN, and ECI. For example, when the MNC, PCI, E-ARFCN, and ECI of the piece of reference cell information are "8", "26", "3743", and "1001", respectively, the piece of reference cell information may be determined as "8_26_3743_1001" and may be input to the embedding layer 411.

In an embodiment, the encoder 412 may extract a feature (e.g., a context vector) of an input sequence (e.g., the piece of reference cell information and the pieces of reference neighboring cell information) by linking RNN-based neural network models together in multiple layers. Additionally, the decoder 422 may model the relationship between the feature extracted by the encoder 412 and the ground truth sequence (e.g., the pieces of neighboring cell information) by linking the RNN-based neural network models together in multiple layers.

The encoder 412 may include an LSTM layer. The LSTM layer may include one or more LSTMs. The encoder 412 may generate a context vector for the piece of reference cell information input through the embedding layer 411. According to an embodiment, when additionally receiving pieces of reference neighboring cell information, the encoder 412 may generate a context vector for the piece of reference cell information and the pieces of reference neighboring cell information. The encoder 412 may transmit the generated context vector to the decoder 422.

The decoder 422 may include LSTM layers. The LSTM layer may include one or more LSTMs. Based on the context vector received from the encoder 412, the decoder 422 may generate one or more pieces of neighboring cell information. When receiving a start word (e.g., "<START>"), an electronic device may generate a piece of neighboring cell information from the context vector through the decoder 422, the dense layer 423, and the softmax layer 424. The electronic device may input the generated piece of neighboring cell information to the embedding layer 421. The decoder 422 may iteratively generate the piece of neighboring cell information based on the context vector and the input piece of neighboring cell information. The decoder 422 may generate one or more pieces of neighboring cell information until an end word (e.g., "<END>") is generated or until one or more pieces of neighboring cell information are generated to reach a predetermined maximum generation length.

For example, when receiving the start word "<START>", the decoder 422 may generate a piece of neighboring cell information "6_211_275_8756" based on the context vector. Here, when the piece of neighboring cell information is "6_211_275_8756," the MNC, PCI, E-ARFCN, and ECI of the piece of neighboring cell information may be "6," "211," "275," and "8756," respectively. The decoder 422 may input the generated piece of neighboring cell information "6_211_275_8756" to the embedding layer 421 and, based on the context vector and the piece of neighboring cell information "6_211_275_8756," generate a new piece of neighboring cell information "6_416_275_3210." The decoder 422 may determine whether the end word "<END>" is generated or whether one or more pieces of neighboring cell information are generated to the predetermined maximum generation length.

The number of one or more LSTMs included in the encoder 412 and the decoder 422 may vary depending on the embodiment. For example, the number of one or more LSTMs may be determined differently depending on the embodiment as one of the hyperparameters for the first model 400.

FIG. 5 is a diagram illustrating a training dataset of a first model, according to an embodiment.

Referring to FIG. 5, a dataset 500 for training the first model may include a piece of position information 510 and pieces of cell information 520 and 530. The labels and pieces of data of the dataset 500 illustrated in FIG. 5 are examples for description, and embodiments are not limited thereto.

The piece of position information 510 may indicate the position of a user terminal that receives a piece of cell information.

The pieces of cell information 520 and 530 may correspond to pieces of cell information for each telecommunication company received at each position of user terminals. The pieces of cell information 520 and 530 may be represented as sequences for each telecommunication company. For example, the pieces of cell information 520 and 530 may be represented in the sequence format "MNC_PCI_E-ARFCN_ECI." The pieces of cell information 520 and 530 received at respective positions may be combined for each telecommunication company and represented as a single sequence. For example, a piece of reference cell information and pieces of reference neighboring cell information received at a position may be represented as a single sequence. For example, a piece of cell information and pieces of neighboring cell information of telecommunication company A received at the position (36.349041, 127.3824997) may be listed as a single sequence and represented as "8_384_1550_16827905 8_434_1550_0 8_434_1694_0 8_384_1694_0."

The piece of cell information 520 and the piece of cell information 530 may be pieces of cell information for different telecommunication companies. In an embodiment, an electronic device may determine the dataset 500 by grouping pieces of cell information of base stations of the same telecommunication company among one or more pieces of cell information and use this dataset to train the first model. In FIG. 5, only two categories of the pieces of cell information 520 and 530 are illustrated in the training dataset 500. However, embodiments are not limited thereto, and the pieces of cell information 520 and 530 may be classified into a plurality of categories depending on the number of telecommunication companies.

The sequences for the pieces of cell information 520 and 530 for the respective telecommunication companies received at the respective positions may correspond to translations of different telecommunication companies. The dataset 500 may be determined such that the sequences for the pieces of cell information 520 and 530 received at the respective positions correspond to each other. For example, in the dataset 500, the ground truth (target label) of the sequence of the piece of cell information 520 of telecommunication company A received at a position may be determined as the sequence of the piece of cell information 530 of telecommunication company B received at the same position. Conversely, the ground truth of the sequence of the piece of cell information 530 of telecommunication company B may be determined as the sequence of the piece of cell information 520 of telecommunication company A received at the same position.

For example, when pieces of cell information of three telecommunication companies (A, B, and C) are received at a predetermined position, datasets for a total of six correspondence relationships, which are different combinations of the three telecommunication companies, may be determined. In this case, to train a model that receives a piece of cell information of telecommunication company A and outputs a piece of cell information of telecommunication company B, the dataset 500 may be determined by assigning the piece of cell information of telecommunication company A and the piece of cell information of telecommunication company B for the respective position as an input and the ground truth, respectively. Additionally, to train a model that receives a piece of cell information of telecommunication company A and outputs a piece of cell information of telecommunication company C, the dataset 500 may be determined by assigning the piece of cell information of telecommunication company A and the piece of cell information of telecommunication company C as an input and a target, respectively. Furthermore, for the input of the piece of cell information of telecommunication company B, two datasets may be determined, each assigning the piece of cell information of telecommunication company A and the piece of cell information of telecommunication company C as targets, respectively. Based on these datasets, separate models that generate the piece of cell information of telecommunication company A and the piece of cell information of telecommunication company C may be trained. In addition, for the input of the piece of cell information of telecommunication company C, two datasets may be determined, each assigning the piece of cell information of telecommunication company A and the piece of cell information of telecommunication company B as targets, respectively. Based on these datasets, separate models that generate the piece of cell information of telecommunication company A and the piece of cell information of telecommunication company B may be trained.

In an embodiment, the electronic device may use one of an LSTM, a bidirectional LSTM, or a GRU as the type cells of an RNN for training the first model. According to an embodiment, the first model may be implemented not only as a Seq-to-Seq model but also as a transformer model. To improve the accuracy of the first model, the number of embedding dimensions, the number of hidden layers, a learning rate, a batch size, the number of epochs may be determined differently depending on the embodiment.

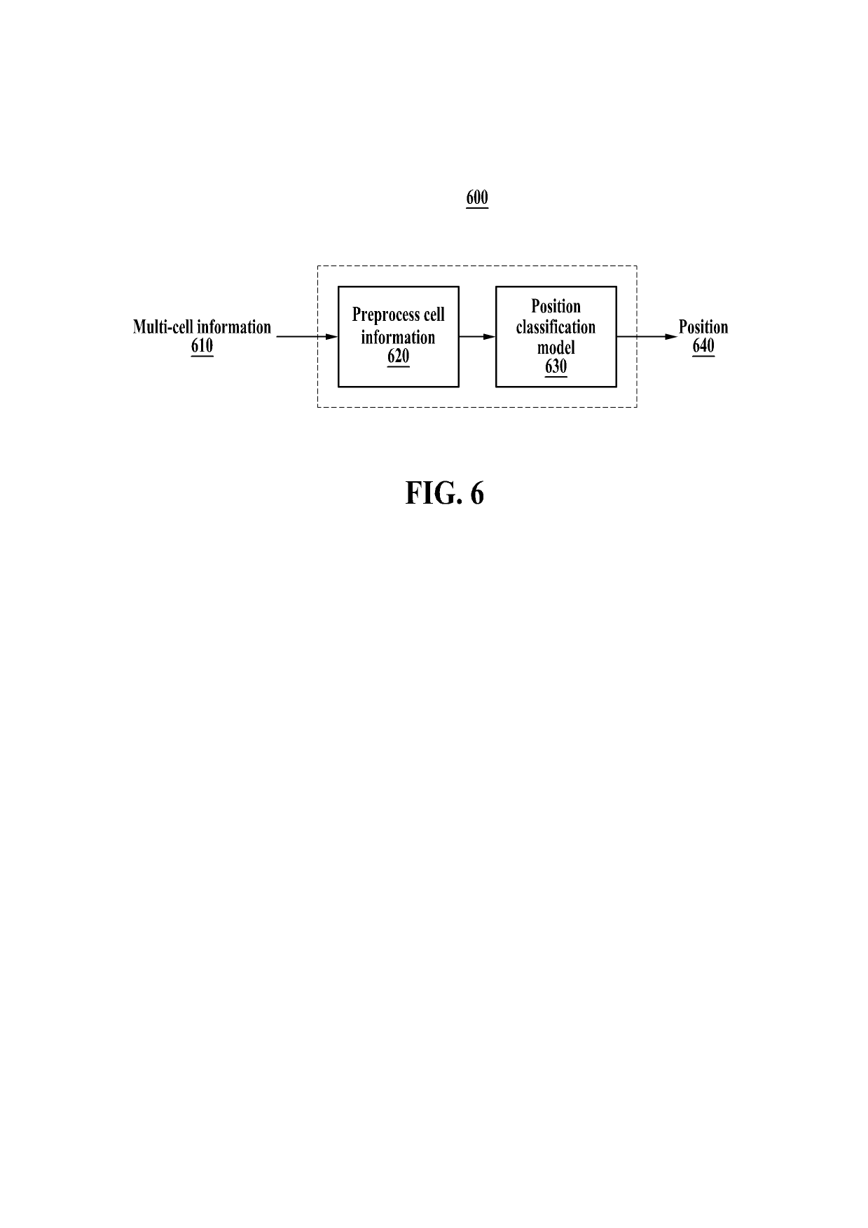

FIG. 6 is a diagram illustrating an operation of determining a position of a user terminal using a second model, according to an embodiment.

Referring to FIG. 6, an example of a functional structure of a second model 600 is illustrated. The second model 600 may include a position classification model 630.

In operation 620, the electronic device may preprocess a piece of multi-cell information 610. Depending on the embodiment, the second model 600 may preprocess the piece of multi-cell information 610 and input the piece of preprocessed multi-cell information 610 to the position classification model 630.

The piece of multi-cell information 610 may include a piece of reference cell information and one or more pieces of neighboring cell information. Additionally, when pieces of reference neighboring cell information are received by the electronic device, the piece of multi-cell information 610 may further include the pieces of reference neighboring cell information.

In an embodiment, the position classification model 630 may determine a position 640 of a user terminal based on the piece of multi-cell information 610. The position classification model 630 may determine a zone (or an index representing a zone) in which the user terminal is positioned among predetermined zones based on the piece of multi-cell information 610. Alternatively, the position classification model 630 may determine the probabilities that the user terminal is positioned in each of the predetermined zones based on the piece of multi-cell information 610. Here, the predetermined zones may represent regions divided into grid-like sections based on latitude and longitude ranges. The position classification model 630 may be pretrained based on a piece of multi-cell information for each position.

The structure and operation of the position classification model 630 is described in detail below with reference to FIG. 7.

FIG. 7 is a diagram illustrating a structure of a second model according to an embodiment.

Referring to FIG. 7, a second model 700 may include an embedding layer 710, an LSTM layer 720, a dense layer 730, and a softmax layer 740. Although the second model 700 of FIG. 7 is implemented based on an LSTM model, embodiments are not limited thereto. The second model 700 may be implemented based on an AI model using diverse training and inference methods.

The second model 700 may receive a piece of multi-cell information. The second model 700 may receive a piece of reference cell information, pieces of reference neighboring cell information, and one or more pieces of neighboring cell information included in the piece of multi-cell information. The one or more pieces of neighboring cell information may include pieces of neighboring cell information of a telecommunication company that is different from the telecommunication company of the piece of reference cell information. The second model 700 may receive the piece of reference cell information and the pieces of reference neighboring cell information from a target user terminal and receive the one or more pieces of neighboring cell information from a first model.

Each of the pieces of cell information included in the piece of multi-cell information input to the second model 700 may be determined as a combination of a piece of telecommunication company information, a cell identifier, and a channel number. For example, each of the pieces of cell information may be determined as a combination of MNC, PCI, E-ARFCN, and ECI. For example, the piece of multi-cell information may include a piece of reference cell information "8_26_3743_1001" with an MNC of "8," a piece of reference neighboring cell information "8_26_1550_0," pieces of neighboring cell information "5_26_3743_1001" and "5_26_1550_0" with an MNC of "5," and pieces of neighboring cell information "6_26_1550_8765" and "6_211_275_3210_" with an MNC of "6."

Each of the pieces of cell information included in the piece of multi-cell information may be sequentially input to the embedding layer 710. The second model 700 may position each of the pieces of cell information included in the piece of multi-cell information in a mutually relational position in a multidimensional space through the embedding layer 710 and the LSTM layer 720.

The second model 700 may determine, using a value output through the embedding layer 710 and the LSTM layer 720, the position through the dense layer 730 and the softmax layer 740. Based on the piece of multi-cell information, the second model 700 may determine the position most closely related with a corresponding piece of cell information. The second model 700 may determine the position as one of the predetermined zones or as a latitude and longitude range corresponding to a corresponding zone. Additionally, the second model 700 may determine the probabilities of being positioned in each of the predetermined zones.

The LSTM layer 720 may include one or more LSTMs. The number of LSTMs included in the LSTM layer 720 may vary depending on the embodiment. For example, the number of LSTMs may be one of the hyperparameters of the second model 700 and may be determined differently depending on the embodiment.

FIG. 8 is a diagram illustrating a training dataset for a second model, according to an embodiment.

Referring to FIG. 8, a dataset 800 for training the second model may include a piece of position information 810, a piece of interval information 820, an identifier 830 for each zone, a piece of latitude and longitude information 840, and pieces of cell information 850. The labels and data illustrated in the dataset 800 in FIG. 8 are examples for description, and embodiments are not limited thereto.

The piece of position information 810 may be the position of a user terminal where a piece of cell information is received. The piece of interval information 820 and the identifier 830 may be an interval and an identifier of the predetermined zones, respectively. The piece of latitude and longitude information 840 may be the latitude and longitude ranges of the predetermined zones. For example, the piece of latitude and longitude information 840 may include information about the maximum latitude, minimum latitude, maximum longitude, and minimum longitude of a corresponding zone.

The pieces of cell information 850 may be a piece of cell information for each telecommunication company received at a position of each of the user terminals. The pieces of cell information 850 may be represented as a sequence for each telecommunication company. For example, the pieces of cell information 850 may be represented in the form of a sequence such as "MNC_PCI_E-ARFCN_ECI." The pieces of cell information 850 received at each position may be combined for each telecommunication company and represented as a single sequence. Each position and the pieces of cell information 850 may be mapped to each other. For example, a piece of mapping information in the dataset 800 may map one of the predetermined zones to a piece of multi-cell information including the pieces of cell information 850 received in a corresponding zone.

The pieces of cell information 850 received at each position may be combined to form a multi-cell information sequence. For example, the multi-cell information sequence may be determined as a combination of the sequences of the pieces of cell information 850 of different telecommunication companies received at a position. The dataset 800 may include multi-cell information sequences according to the position of the user terminal. When the dataset 800 inputs the piece of multi-cell information sequence including the pieces of cell information 850, the second model may be trained to determine a position corresponding to the ground truth for a corresponding sequence. For example, when the pieces of cell information 850 of three telecommunication companies are obtained, in the dataset 800 used to train the second model, the multi-cell information sequences for the three telecommunication companies at the same position may be determined as an input, and a corresponding position (or the identifier 830 of the corresponding position) may be determined as the ground truth.

In an embodiment, an electronic device may use one of an LSTM, a bidirectional LSTM, or a GRU as the type of cells of an RNN for training the second model. To improve the accuracy of the second model, the number of embedding dimensions, the number of hidden layers, a learning rate, a batch size, and the number of epochs may be determined differently depending on the embodiment.

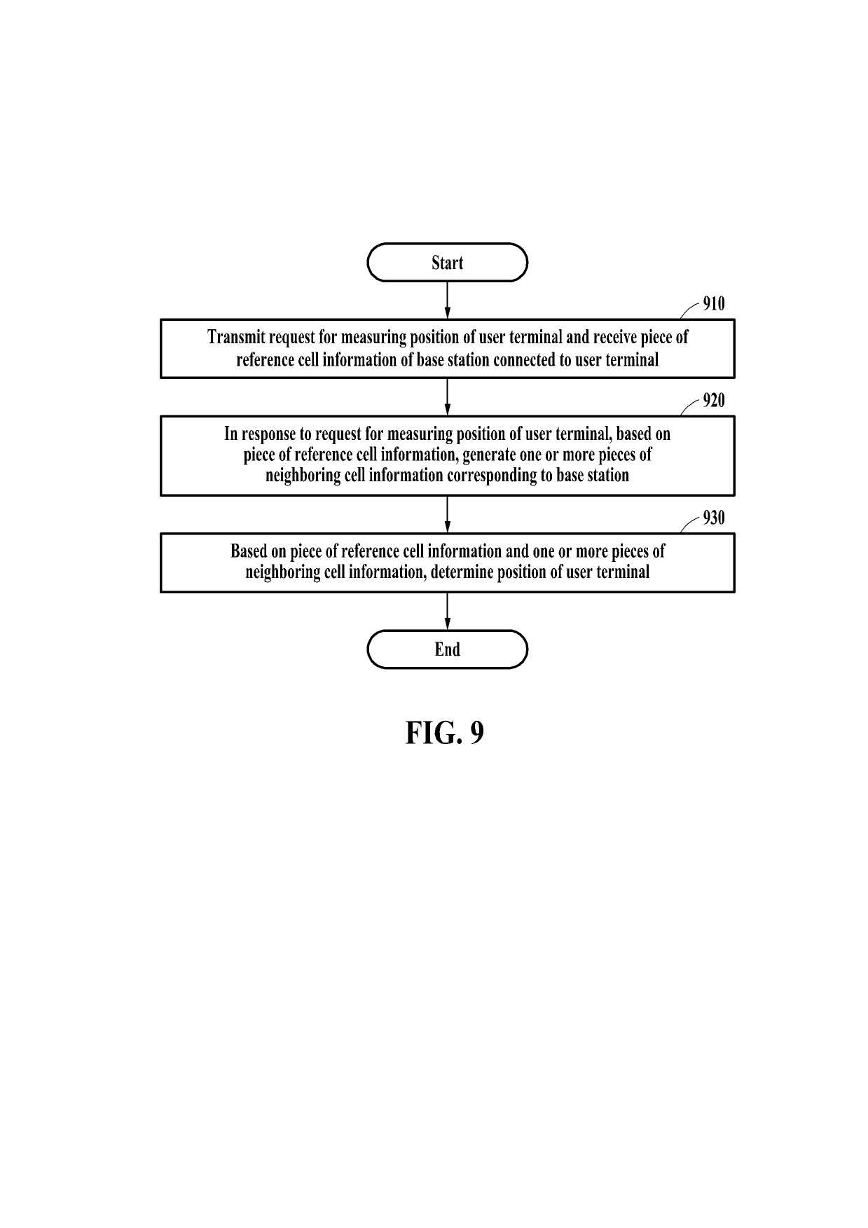

FIG. 9 is a flowchart illustrating a method of operating an electronic device during an inference process, according to an embodiment.

In the following embodiments, operations may be performed sequentially but not necessarily. For example, the order of the operations may change, and at least two of the operations may be performed in parallel. Operations 910 to 930 may be performed by at least one component (e.g., a processor, etc.) of the electronic device.

In operation 910, the electronic device may receive a request for measuring a position of a user terminal and a piece of reference cell information of a base station connected to the user terminal. The electronic device may further receive pieces of reference neighboring cell information of base stations of a telecommunication company that is the same as the telecommunication company of the base station.

In operation 920, in response to the request for measuring the position of the user terminal, the electronic device may generate one or more pieces of neighboring cell information corresponding to the base station based on the piece of reference cell information. The electronic device may generate the one or more pieces of neighboring cell information using a first model that is pretrained with a sequence that lists the piece of reference cell information and the pieces of one or more neighboring cell information corresponding to the piece of reference cell information. The electronic device may generate the one or more pieces of neighboring cell information based on the piece of reference cell information and the pieces of reference neighboring cell information.

In operation 930, the electronic device may determine the position of the user terminal based on the piece of reference cell information and the one or more pieces of neighboring cell information. The electronic device may determine the position of the user terminal using a second model that is pretrained with a piece of multi-cell information including the piece of reference cell information and the one or more pieces of neighboring cell information. The electronic device may determine the probabilities of the user terminal being positioned in each of the predetermined zones.

The first model may include an LSTM layer that generates a context vector based on the piece of reference cell information and the pieces of reference neighboring cell information. The second model may include an LSTM layer for determining a position corresponding to the piece of multi-cell information. The one or more pieces of neighboring cell information may include pieces of cell information of a base station of a telecommunication company that is different from the base station of the one or more pieces of neighboring cell information.

The above descriptions provided with reference to FIGS. 1 to 8 may apply to the operations illustrated in FIG. 9, and thus further detailed descriptions thereof are not provided here.

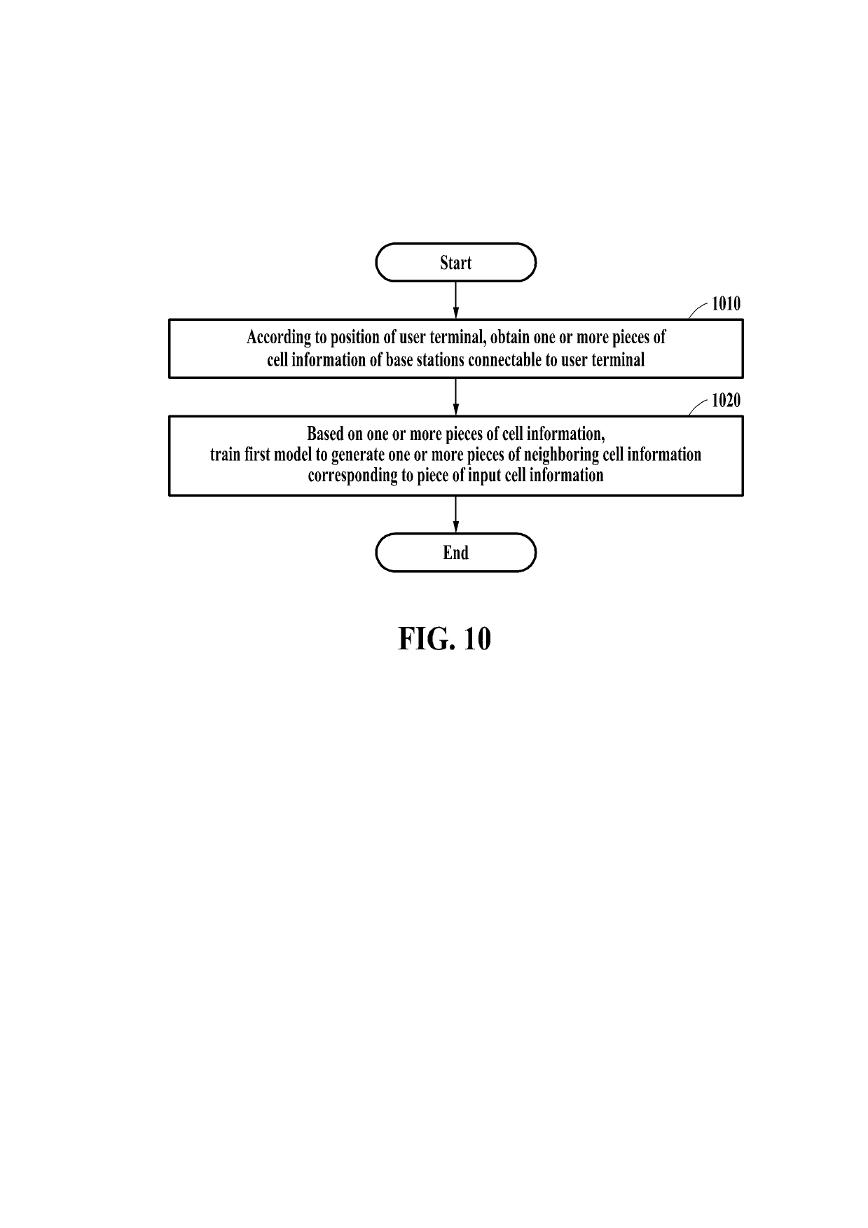

FIG. 10 is a flowchart illustrating a method of operating an electronic device in a training process, according to an embodiment.

In the following embodiments, operations may be performed sequentially but not necessarily. For example, the order of the operations may change, and at least two of the operations may be performed in parallel. Operations 1010 and 1020 may be performed by at least one component (e.g., a processor, etc.) of the electronic device.

In operation 1010, the electronic device may obtain one or more pieces of cell information of base stations connectable to a user terminal, according to the position of the user terminal.

In operation 1020, the electronic device may train the first model to generate the one or more pieces of neighboring cell information corresponding to a piece of input cell information based on the one or more pieces of cell information. The electronic device may train the first model by grouping the pieces of cell information of base stations of the same telecommunication company among the one or more pieces of cell information. Each of the one or more pieces of cell information may include a cell identifier and a channel number for a corresponding cell. The electronic device may generate sequences based on the cell identifiers and channel numbers of the one or more pieces of cell information and train the first model by matching the generated sequences to one another based on a telecommunication company.

The electronic device may train the second model to determine the position of the user terminal corresponding to the piece of input cell information based on the piece of multi-cell information including the one or more pieces of cell information. The electronic device may train the second model based on a piece of mapping information between the piece of multi-cell information and a zone corresponding to the position of the user terminal among the predetermined zones.

The above descriptions provided with reference to FIGS. 1 to 8 may apply to the operations illustrated in FIG. 10, and thus further detailed descriptions thereof are not provided here.

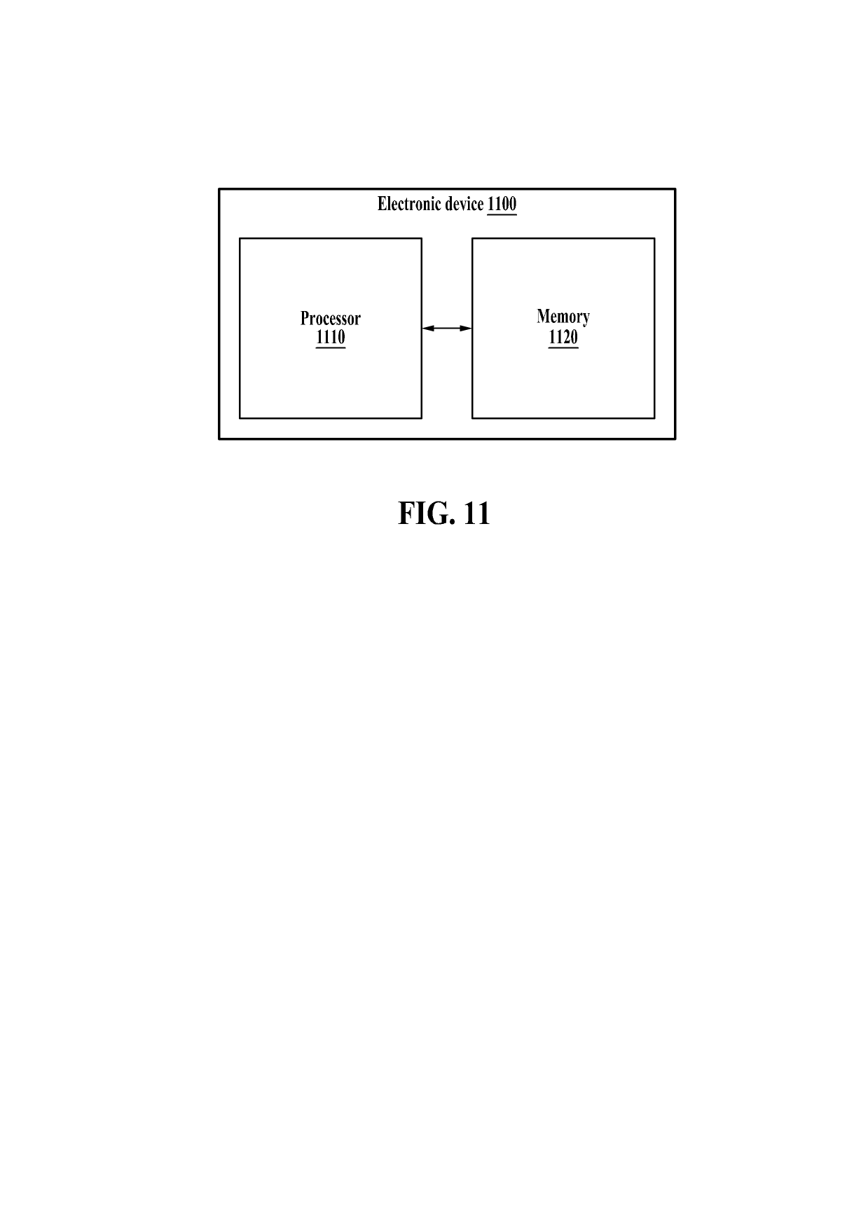

FIG. 11 is a block diagram illustrating an electronic device according to an embodiment.

Referring to FIG. 11, an electronic device 1100 may include a processor 1110. The processor 1110 may include at least one processor. Additionally, the electronic device 1100 may further include a memory 1120.

The memory 1120 may store instructions (e.g., a program) executable by the processor 1110. For example, the instructions may include instructions for executing an operation of the processor 1110 and/or instructions for executing an operation of each component of the processor 1110.

The processor 1110 may be a device that executes instructions or programs or controls the electronic device 1110 and may include various processors such as a central processing unit (CPU) and a graphics processing unit (GPU). The processor 1110 may receive a request for a position of a user terminal and a piece of reference cell information of a base station connected to the user terminal. In response to the request for the position of the user terminal, the processor 1110 may generate one or more pieces of neighboring cell information corresponding to a base station based on the piece of reference cell information. The processor 1110 may determine the position of the user terminal based on the piece of reference cell information and the one or more pieces of neighboring cell information.

The processor 1110 may generate the one or more pieces of neighboring cell information using the first model that is pretrained with a sequence that lists the piece of reference cell information and the one or more pieces of neighboring cell information corresponding to the piece of reference cell information. The processor 1110 may further receive pieces of reference neighboring cell information of base stations of a telecommunication company that is the same as the telecommunication company of the base station and generate the one or more pieces of neighboring cell information based on the piece of reference cell information and the pieces of reference neighboring cell information. The processor 1110 may determine the position of the user terminal using the second model that is pretrained with a piece of multi-cell information including the piece of reference cell information and the one or more pieces of neighboring cell information and a position. The processor 1110 may determine the probabilities that the user terminal is positioned each of predetermined zones.

The processor 1110 may obtain one or more pieces of cell information of base stations connectable to the user terminal, according to the position of the user terminal. The processor 1110 may train the first model to generate the one or more pieces of neighboring cell information corresponding to the piece of input cell information based on the one or more pieces of cell information.

The processor 1110 may train the first model by grouping pieces of cell information of base stations of the same telecommunication company among the one or more pieces of cell information. The processor 1110 may train the second model to determine the position of the user terminal corresponding to the piece of input cell information based on the piece of multi-cell information including the one or more pieces of cell information. The processor 1110 may also train the second model based on the piece of mapping information between the piece of multi-cell information and a zone corresponding to the position of the user terminal among the predetermined zones.

Additionally, the electronic device 1100 may process the operations described above.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. For example, the device, the method, and the components described in the embodiments may be implemented using a general-purpose or special-purpose computer, such as a processor, a controller and an arithmetic logic unit (ALU), a DSP, a microcomputer, an FPGA, a programmable logic unit (PLU), a microprocessor, or any other devices capable of responding to and executing instructions. A processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and multiple types of processing elements. For example, the processing device may include a plurality of processors or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored in a non-transitory computer-readable storage medium.

The method according to the embodiments described above may be recorded in the computer-readable storage medium including program instructions to implement various operations of the embodiments described above. The computer-readable storage medium may also include, alone or in combination with the program instructions, data files, data structures, and the like. The program instructions recorded on the medium may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as ROM, random access memory (RAM), flash memory, and the like. Examples of program instructions include both machine code, such as produced by a compiler, and files containing higher-level code that may be executed by the computer using an interpreter.

The hardware devices described above may be configured to act as one or more software modules in order to perform the operations of the embodiments described above, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A method of operating an electronic device, the method comprising:
receiving a request for measuring a position of a user terminal and a piece of reference cell information of a base station connected with the user terminal;
in response to the request for measuring the position of the user terminal, based on the piece of reference cell information, generating one or more pieces of neighboring cell information corresponding to the base station; and
based on the piece of reference cell information and the one or more pieces of neighboring cell information, determining the position of the user terminal.

2. The method of claim 1, wherein the generating of the one or more pieces of neighboring cell information comprises, using a first model that is pretrained with a sequence of the piece of reference cell information and the one or more pieces of neighboring cell information corresponding to the piece of reference cell information, generating the one or more pieces of neighboring cell information.

3. The method of claim 2, wherein
the receiving of the piece of reference cell information further comprises receiving pieces of reference neighboring cell information of base stations of a telecommunication company that is same as a telecommunication company of the base station, and
the generating of the one or more pieces of neighboring cell information comprises, based on the piece of reference cell information and the pieces of reference neighboring cell information, generating the one or more pieces of neighboring cell information.

4. The method of claim 3, wherein the first model comprises a long short-term memory (LSTM) layer configured to generate a context vector based on the piece of reference cell information and the pieces of reference neighboring cell information.

5. The method of claim 1, wherein the determining of the position of the user terminal comprises, using a second model that is pretrained with a piece of multi-cell information comprising the piece of reference cell information and the one or more pieces of neighboring cell information and a position, determining the position of the user terminal.

6. The method of claim 5, wherein the second model comprises a long short-term memory (LSTM) layer for determining a position corresponding to the piece of multi-cell information.

7. The method of claim 1, wherein the one or more pieces of neighboring cell information comprise pieces of cell information of a base station of a telecommunication company that is different from a telecommunication company of the base station.

8. The method of claim 1, wherein the determining of the position of the user terminal comprises determining probabilities that the user terminal is positioned in each of predetermined zones.

9. A method of operating an electronic device, the method comprising:
according to a position of a user terminal, obtaining one or more pieces of cell information of base stations connectable to the user terminal; and
based on the one or more pieces of cell information, training a first model to generate one or more pieces of cell information corresponding to a piece of input cell information.

10. The method of claim 9, wherein the training of the first model comprises training the first model by grouping pieces of cell information of base stations of a same telecommunication company among the one or more pieces of cell information.

11. The method of claim 9, wherein
each of the one or more pieces of cell information comprises a cell identifier and a channel number of a corresponding cell, and
the training of the first model comprises training the first model by generating sequences based on the cell identifier and the channel number of each of the one or more pieces of cell information and matching the generated sequences to one another based on a telecommunication company.

12. The method of claim 9, further comprising:
based on a piece of multi-cell information comprising the one or more pieces of cell information, training a second model to determine the position of the user terminal corresponding to the piece of input cell information.

13. The method of claim 12, wherein the training of the second model comprises, based on a piece of mapping information between a zone corresponding to the position of the user terminal among predetermined zones and the piece of multi-cell information, training the second model.

14. An electronic device comprising:
a processor; and
a memory storing instructions,
wherein the instructions, when executed by the processor, cause the electronic device to:
receive a request for a position of a user terminal and a piece of reference cell information of a base station connected with the user terminal;
in response to the request for the position of the user terminal, based on the piece of reference cell information, generate one or more pieces of neighboring cell information corresponding to the base station; and
based on the piece of reference cell information and the one or more pieces of neighboring cell information, determine the position of the user terminal.

15. The electronic device of claim 14, wherein the instructions, when executed by the processor, cause the electronic device to, using a first model that is pretrained with a sequence of the piece of reference cell information and the one or more pieces of neighboring cell information corresponding to the piece of reference cell information, generate the one or more pieces of neighboring cell information.

16. The electronic device of claim 15, wherein the instructions, when executed by the processor, cause the electronic device to:
further receive pieces of reference neighboring cell information of base stations of a telecommunication company that is same as a telecommunication company of the base station; and
based on the piece of reference cell information and the pieces of reference neighboring cell information, generate the one or more pieces of neighboring cell information.

17. The electronic device of claim 16, wherein the first model comprises a long short-term memory (LSTM) layer configured to generate a context vector based on the piece of reference cell information and the pieces of reference neighboring cell information.

18. The electronic device of claim 14, wherein the instructions, when executed by the processor, cause the electronic device to, using a second model that is pretrained with a piece of multi-cell information comprising the piece of reference cell information and the one or more pieces of neighboring cell information and a position, determine the position of the user terminal.

19. The electronic device of claim 18, wherein the second model comprises a long short-term memory (LSTM) layer for determining a position corresponding to the multi-cell information.

20. The electronic device of claim 14, wherein the one or more pieces of neighboring cell information comprise pieces of cell information of a base station of a telecommunication company that is different from a telecommunication company of the base station.
